(19) United States
(12) Patent Application Publication
(10) Pub. No.: US 2015/0192277 A1
(43) Pub. Date: Jul. 9, 2015

(54) PANEL LAMP WITH AN EASILY ASSEMBLED LAMPSHADE

(71) Applicant: LEXTAR ELECTRONICS CORPORATION, Hsinchu (TW)

(72) Inventor: Chin-Chu YU, Hsinchu County (TW)

(73) Assignee: LEXTAR ELECTRONICS CORPORATION, Hsinchu (TW)

(21) Appl. No.: 14/274,644

(22) Filed: May 9, 2014

(30) Foreign Application Priority Data
Jan. 3, 2014 (TW) 103100144

(51) Int. Cl. F21V 15/01; F21V 1/00; F21V 17/16; F21V 7/00

(52) U.S. Cl. CPC F21V 15/01; F21V 7/0025; F21V 1/00; F21V 17/164; F21Y 2101/02

(57) ABSTRACT

A panel lamp includes a lamp housing, multiple first punched holes, multiple second punched holes, multiple first protruding bent portions, multiple second protruding bent portions, a light source module, and a lampshade. The lamp housing includes a first side plate and a second side plate opposite thereto. The first and second side plates respectively include a first folded portion and a second folded portion. Each first protruding bent portion is adjacent to each first punched hole. The first protruding bent portions and first folded portion form a first fixing mechanism. Each second protruding bent portion is adjacent to each second punched hole. The second protruding bent portions and second folded portion form a second fixing mechanism. The lampshade includes a first edge and a second edge. The first and second edges are respectively held by the first and second fixing mechanisms and are fixed to the lamp housing.

### CROSS REFERENCE TO RELATED APPLICATIONS

This Application claims priority of Taiwan Patent Application No. 103100144, filed on Jan. 3, 2014, the entirety of which is incorporated by reference herein.

### BACKGROUND OF THE INVENTION

1. Field of the Invention

The invention relates to a panel lamp, and more particularly to a panel lamp with a lampshade that can be easily assembled and positioned on a lamp housing.

2. Description of the Related Art

A conventional panel lamp often employs an optical element (i.e. a lampshade) with a large area to achieve a light-mixing effect. The optical element (lampshade) is fixed by a positioning mechanism arranged on a lamp housing of the conventional panel lamp. Here, the positioning mechanism is composed of a sidewall on the lamp housing and an L-shaped sheet metal piece. Specifically, the L-shaped sheet metal piece is often riveted to the sidewall by a rivet, forming a groove on the lamp housing. Then, the optical element (lampshade) is fit in the groove and is thus fixed to the lamp housing.

Nevertheless, when the L-shaped sheet metal piece is riveted to the sidewall by the rivet, a large tolerance is easily generated between the L-shaped sheet metal piece and the sidewall. Accordingly, poor groove flatness, distortion of the optical element (lampshade), light leakage, and poor seal tightness are problematic for the conventional panel lamp, thereby causing deviation of a profile of light output from the conventional panel lamp. Moreover, as the L-shaped sheet metal piece is riveted to the sidewall by the rivet, manufacture of the conventional panel lamp is complex and time-consuming.

Hence, there is a need for a panel lamp with simplified assembly, enhanced manufacturing yield, and improved luminous efficacy.

### BRIEF SUMMARY OF THE INVENTION

A detailed description is given in the following embodiments with reference to the accompanying drawings.

An exemplary embodiment of the invention provides a panel lamp comprising a lamp housing, a plurality of first punched holes, a plurality of second punched holes, a plurality of first protruded bent portions, a plurality of second protruded bent portions, a light source module, and a lampshade. The lamp housing comprises a base plate, a front plate, a rear plate, a first side plate, and a second side plate opposite to the first side plate. The front plate, rear plate, first side plate, and second side plate are connected to the base plate. The front plate is opposite to the rear plate. The front and rear plates are connected between the first and second side plates. The first and second side plates respectively comprise a first folded portion and a second folded portion. The first and second folded portions are opposite to each other. The first punched holes are separated from each other and are formed in a position, near the first folded portion, of the first side plate. The second punched holes are separated from each other and are formed in a position, near the second folded portion, of the second side plate. Each first protruded bent portion is adjacent to each first punched hole. The first protruded bent portions and first folded portion form a first fixing mechanism. Each second protruded bent portion is adjacent to each second punched hole. The second protruded bent portions and second folded portion form a second fixing mechanism. The light source module is disposed in the lamp housing. The lampshade comprises a first edge, a second edge, a third edge, and a fourth edge. The first and second edges are opposite to each other. The third and fourth edges are adjacent to the first and second edges and are opposite to each other. The first and second edges are respectively held by the first and second fixing mechanisms and are fixed to the lamp housing. Light from the light source module is output to the exterior of the lamp housing through the lampshade.

The first and second folded portions are parallel to the base plate.

Each first protruded bent portion is formed by the first side plate, originally located in each first punched hole, bending toward the second side plate and first folded portion. Each second protruded bent portion is formed by the second side plate, originally located in each second punched hole, bending toward the first side plate and second folded portion.

Each first protruded bent portion and each second protruded bent portion tilt to the base plate by an inclined angle. The inclined angle comprises an acute angle.

The third and fourth edges of the lampshade respectively cover the front and rear plates.

The panel lamp further comprises a first barrier plate and a second barrier plate respectively disposed on one side, adjacent to the lampshade, of the front and rear plates, blocking the third and fourth edges of the lampshade.

An included angle between the first side plate and the base plate and an included angle between the second side plate and the base plate exceed 90°.

The lamp housing is integrally formed.

The light source module comprises at least one light-emitting diode.

The panel lamp further comprises a plurality of reflective sheets respectively disposed on the base plate and/or first side plate, the second side plate and/or front plate, and the rear plate within the lamp housing.

### BRIEF DESCRIPTION OF THE DRAWINGS

The invention can be more fully understood by reading the subsequent detailed description and examples with references made to the accompanying drawings, wherein:

FIG. 1 is a schematic perspective view of a panel lamp of the invention;

FIG. 2 is a schematic front view of the panel lamp of the invention;

FIG. 3 is a schematic top view of the panel lamp of the invention, from which a lampshade is removed; and

FIG. 4 is a schematic cross section taken along line A-A′ of FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

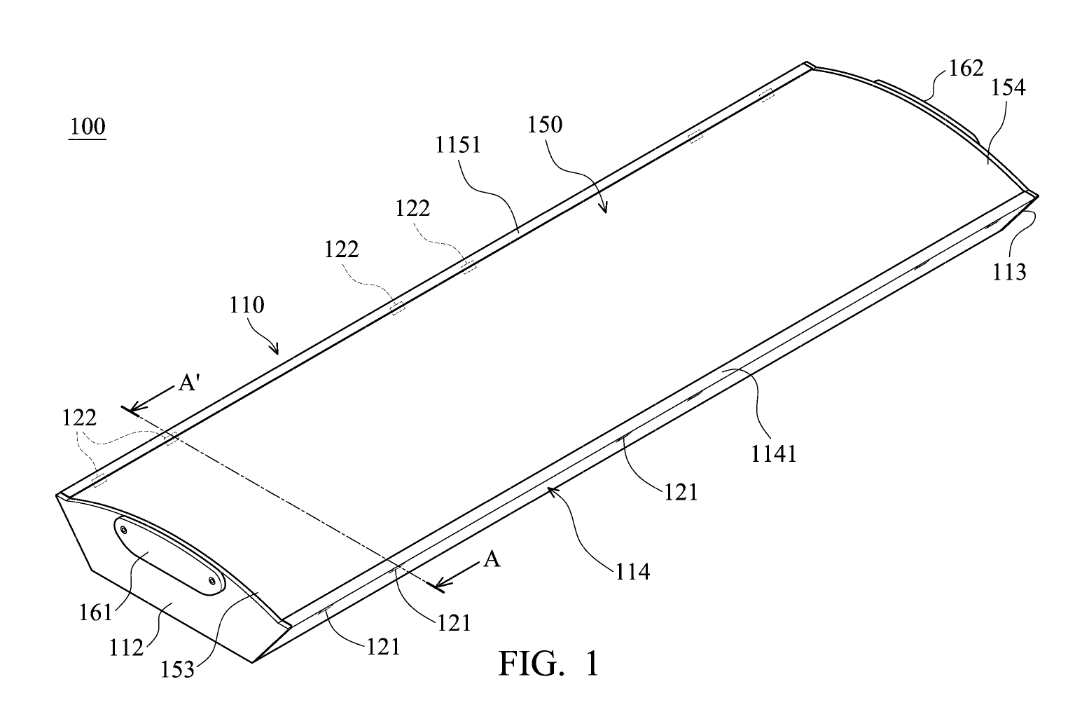

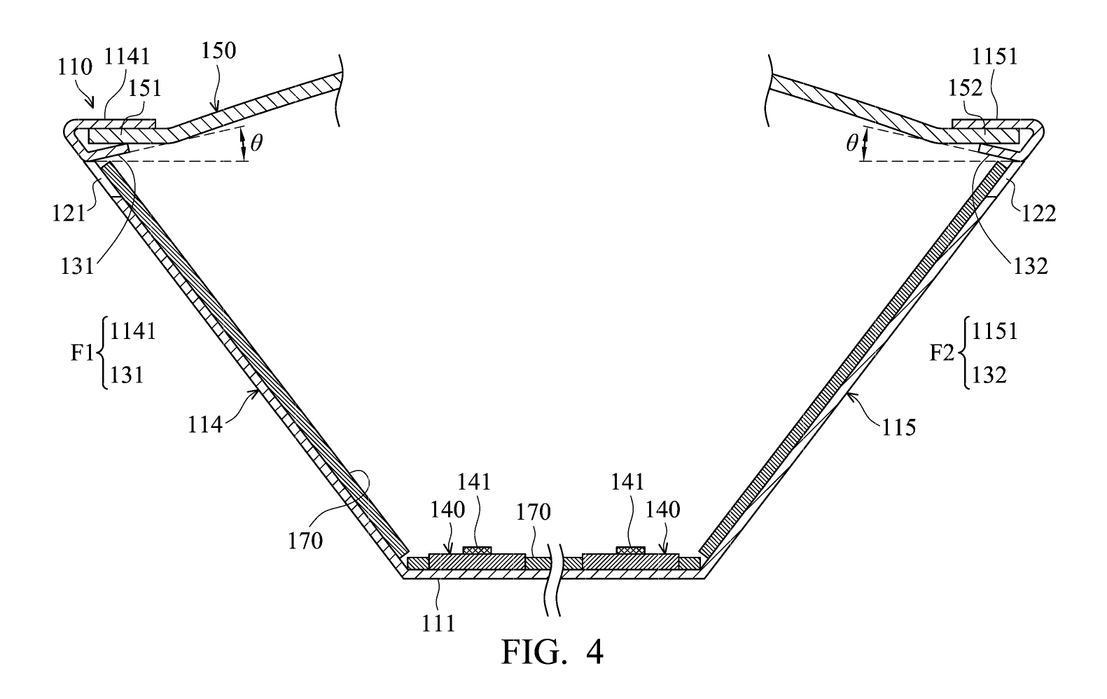

Referring to FIG. 1 and FIG. 4, a panel lamp 100 comprises a lamp housing 110, a plurality of first punched holes 121 separated from each other, a plurality of second punched holes 122 separated from each other, a plurality of first protruded bent portions 131, a plurality of second protruded bent portions 132, a plurality of light source modules 140, a lampshade 150, a first barrier plate 161, a second barrier plate 162, and a plurality of reflective sheets 170.

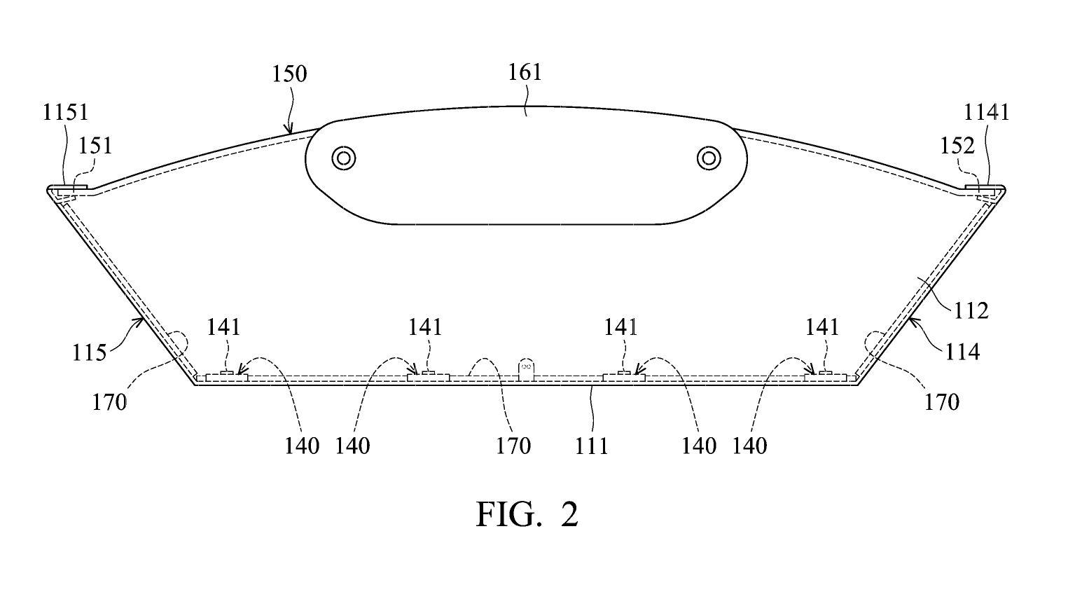

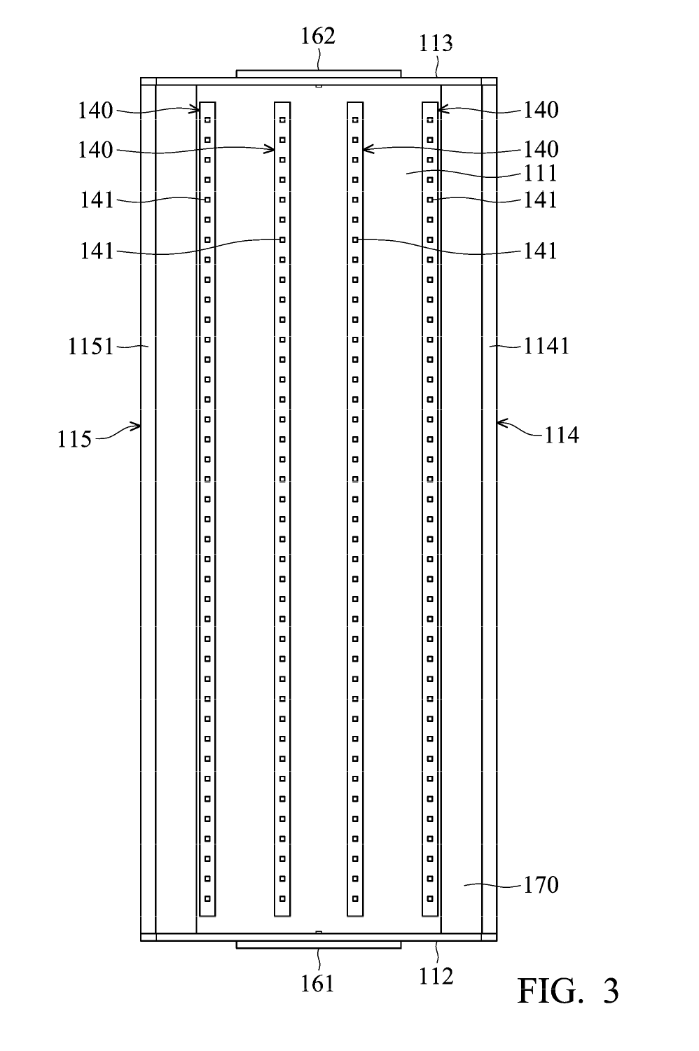

As shown in FIGS. 2, 3, and 4, the lamp housing 110 comprises a base plate 111, a front plate 112, a rear plate 113, a first side plate 114, and a second side plate 115. Here, the first side plate 114 is opposite to the second side plate 115, the front plate 112, rear plate 113, first side plate 114, and second side plate 115 are connected to the base plate 111, the front plate 112 is opposite to the rear plate 113, and the front plate 112 and rear plate 113 are connected between the first side plate 114 and the second side plate 115. Moreover, the first side plate 114 and second side plate 115 respectively comprise a first folded portion 1141 and a second folded portion 1151. Here, the first folded portion 1141 and second folded portion 1151 are opposite to each other. Additionally, as shown in FIG. 2 and FIG. 4, the first folded portion 1141 and second folded portion 1151 are parallel to the base plate 111. Moreover, as shown in FIG. 2 and FIG. 4, an included angle between the first side plate 114 and the base plate 111 and an included angle between the second side plate 115 and the base plate 111 exceed 90°. Furthermore, in this embodiment, the lamp housing 110 is integrally formed.

As shown in FIG. 1 and FIG. 4, the first punched holes 121 are separated from each other and are formed in a position, near the first folded portion 1141, of the first side plate 114. In another aspect, the second punched holes 122 are separated from each other and are formed in a position, near the second folded portion 1151, of the second side plate 115.

As shown in FIG. 4, each first protruded bent portion 131 is adjacent to each first punched hole 121, and the first protruded bent portions 131 and first folded portion 1141 form a first fixing mechanism F1. Specifically, each first protruded bent portion 131 is formed by the first side plate 114, originally located in each first punched hole 121, bending toward the second side plate 115 and first folded portion 1141.

Each second protruded bent portion 132 is adjacent to each second punched hole 122, and the second protruded bent portions 132 and second folded portion 1151 form a second fixing mechanism F2. Specifically, each second protruded bent portion 132 is formed by the second side plate 115, originally located in each second punched hole 122, bending toward the first side plate 114 and second folded portion 1151.

Moreover, in this embodiment, each first protruded bent portion 131 and each second protruded bent portion 132 tilt to the base plate 111 by an inclined angle θ, and the inclined angle θ is an acute angle.

As shown in FIGS. 2, 3, and 4, the light source modules 140 are disposed in the lamp housing 110. Here, each light source module 140 comprises at least one light-emitting diode 141.

As shown in FIGS. 1, 2, and 4, the lampshade 150 comprises a first edge 151, a second edge 152, a third edge 153, and a fourth edge 154. The first edge 151 and second edge 152 are opposite to each other. The third edge 153 and fourth edge 154 are adjacent to the first edge 151 and second edge 152 and are opposite to each other. Here, the first edge 151 and second edge 152 are respectively held by the first fixing mechanism F1 and second fixing mechanism F2 and are fixed to the lamp housing 110, and light from the light source modules 140 is output to the exterior of the lamp housing 110 through the lampshade 150. Moreover, the third edge 153 and fourth edge 154 respectively cover the front plate 112 and rear plate 113.

As shown in FIGS. 1, 2, and 3, the first barrier plate 161 and second barrier plate 162 are respectively disposed on one side, adjacent to the lampshade 150, of the front plate 112 and rear plate 113, blocking the third edge 153 and fourth edge 154 of the lampshade 150.

As shown in FIGS. 2, 3, and 4, the reflective sheets 170 are respectively disposed on the base plate 111 and/or first side plate 114, the second side plate 115 and/or front plate 112, and the rear plate 113 within the lamp housing 110, reflecting the light from the light source modules 140 to enhance luminous efficiency.

As shown in FIG. 4, during assembly of the panel lamp 100, the first protruded bent portions 131 and second protruded bent portions 132 can be punched to be approximately parallel to the base plate 111 in advance. After the lampshade 150 slides into the first fixing mechanism F1 and second fixing mechanism F2, the first protruded bent portions 131 and second protruded bent portions 132 are bent manually or by tools to provide the inclined angle θ, respectively and tightly holding the first edge 151 and second edge 152 of the lampshade 150 on the first fixing mechanism F1 and second fixing mechanism F2. Then, the first barrier plate 161 and second barrier plate 162 are respectively disposed on the front plate 112 and rear plate 113 of the lamp housing 110, enabling the lampshade 150 to be completely fixed to the lamp housing 110.

In conclusion, in the panel lamp 100, the lamp housing 110 is integrally formed and utilizes the first protruded bent portions 131 and second protruded bent portions 132 formed by punching and the first fixing mechanism F1 and second fixing mechanism F2 formed by the first folded portion 1141 and second folded portion 1151 to fix the lampshade 150. Thus, manufacture and assembly of the panel lamp 100 can be very fast. Moreover, as the lampshade 150 can be precisely positioned in the lamp housing 110, lampshade looseness and light leakage due to tolerances resulting from the use of rivets can be prevented, enhancing the quality of the panel lamp 100.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A panel lamp, comprising:
a lamp housing comprising a base plate, a front plate, a rear plate, a first side plate, and a second side plate opposite to the first side plate, wherein the front plate, rear plate, first side plate, and second side plate are connected to the base plate, the front plate is opposite to the rear plate, the front and rear plates are connected between the first and second side plates, the first and second side plates respectively comprise a first folded portion and a second folded portion, and the first and second folded portions are opposite to each other;
a plurality of first punched holes separated from each other and formed in a position, near the first folded portion, of the first side plate;
a plurality of second punched holes separated from each other and formed in a position, near the second folded portion, of the second side plate;
a plurality of first protruded bent portions, wherein each first protruded bent portion is adjacent to each first punched hole, and the first protruded bent portions and first folded portion form a first fixing mechanism;
a plurality of second protruded bent portions, wherein each second protruded bent portion is adjacent to each second punched hole, and the second protruded bent portions and second folded portion form a second fixing mechanism;
a light source module disposed in the lamp housing; and
a lampshade comprising a first edge, a second edge, a third edge, and a fourth edge, wherein the first and second edges are opposite to each other, the third and fourth edges are adjacent to the first and second edges and are opposite to each other, the first and second edges are respectively held by the first and second fixing mechanisms and are fixed to the lamp housing, and light from the light source module is output to the exterior of the lamp housing through the lampshade.

2. The panel lamp as claimed in claim 1, wherein the first and second folded portions are parallel to the base plate.

3. The panel lamp as claimed in claim 2, wherein each first protruded bent portion is formed by the first side plate, originally located in each first punched hole, bending toward the second side plate and first folded portion, and each second protruded bent portion is formed by the second side plate, originally located in each second punched hole, bending toward the first side plate and second folded portion.

4. The panel lamp as claimed in claim 3, wherein each first protruded bent portion and each second protruded bent portion tilt to the base plate by an inclined angle, and the inclined angle comprises an acute angle.

5. The panel lamp as claimed in claim 1, wherein the third and fourth edges of the lampshade respectively cover the front and rear plates.

6. The panel lamp as claimed in claim 5, further comprising a first barrier plate and a second barrier plate respectively disposed on one side, adjacent to the lampshade, of the front and rear plates, blocking the third and fourth edges of the lampshade.

7. The panel lamp as claimed in claim 1, wherein an included angle between the first side plate and the base plate and an included angle between the second side plate and the base plate exceed 90°.

8. The panel lamp as claimed in claim 1, wherein the lamp housing is integrally formed.

9. The panel lamp as claimed in claim 8, wherein the light source module comprises at least one light-emitting diode.

10. The panel lamp as claimed in claim 9, further comprising a plurality of reflective sheets respectively disposed on the base plate and/or first side plate, the second side plate and/or front plate, and the rear plate within the lamp housing.
